(19) United States
(12) Patent Application Publication
(10) Pub. No.: US 2025/0198528 A1
(43) Pub. Date: Jun. 19, 2025

(54) RECIPROCATING SWITCH FOR HIGH-PRESSURE FLUID LINES

(71) Applicant: LI CHUNG PLASTICS INDUSTRY CO., LTD., TAICHUNG CITY (TW)

(72) Inventor: Tony HSU, TAICHUNG CITY (TW)

(21) Appl. No.: 18/924,836

(22) Filed: Oct. 23, 2024

(30) Foreign Application Priority Data
Dec. 14, 2023 (TW) 112213686

(51) Int. Cl. F16K 24/02

(52) U.S. Cl. CPC F16K 24/02

(57) ABSTRACT

A reciprocating switch for high-pressure fluid lines comprises an inlet switch body, an outlet switch body, a first communication port, a second communication port, and a sleeve. The inlet switch body has an inlet at one end and a closed end at other end with an inlet chamber therebetween that communicates with the inlet. The outlet switch body extends from the closed end of the inlet switch body and features an outlet at its outer end with an outlet chamber therein that communicates with the outlet. The first and second communication ports communicate interior and exterior of the inlet and outlet switch bodies, respectively, and the sleeve is reciprocable and fits over outer surfaces of both switch bodies with an annular groove in its inner wall communicating with both communication ports or only the first communication port.

### FIELD OF INVENTION

The present invention pertains to a fluid control switch and more particularly to a reciprocating switch for high-pressure fluid lines.

### BACKGROUND OF THE INVENTION

High-pressure gas cylinders, such as gas tanks, oxygen cylinders, and acetylene cylinders, typically have a pressure-reducing valve installed on the outlet or flow path side of the cylinder body to discharge low-pressure fluid. The elastic actuation direction of this pressure-reducing valve is generally perpendicular to the direction of fluid flow.

Another type of pressure-reducing valve is the direct-communicating pressure-reducing valve, which is directly connected to the flow path. In this valve, the elastic actuation direction of the pressure-reducing mechanism is generally parallel to the fluid flow direction. These valves are used to supply fluid to fluid-driven devices such as guns, riot control guns, nail guns, or pneumatic wrenches. Typically, the gas pressure in a cylinder using this type of valve is around 3000 psi, and the pressure is reduced to approximately 900-1000 psi after passing through the valve. When a fluid-driven device is not in use or after the cylinder is depleted, residual pressure often remains in the device, such as a gun or riot control gun. To safely disassemble the device, it is usually necessary to pull the trigger once to release the remaining gas pressure and prevent the residual pressure from obstructing the connection mechanism between the device and the pressure-reducing valve so that the device can be conveniently disassembled. However, users may not always be aware of this procedure, which may result in difficulties during disassembly. Therefore, there is a need to develop and design a fluid control switch that enables users to quickly and easily disassemble fluid-driven devices when not in use.

### SUMMARY OF THE INVENTION

Therefore, it is a primary purpose of the present invention is to provide a reciprocating switch for high-pressure fluid lines, enabling a fluid-driven device to be quickly and easily disassembled.

A secondary purpose of the present invention is to provide a reciprocating switch for high-pressure fluid lines, allowing residual gas pressure in the fluid-driven device to be quickly and easily released.

To accomplish the aforementioned purposes, the present invention provides a reciprocating switch for high-pressure fluid lines, comprising an inlet switch body, an outlet switch body, a first communication port, a second communication port, and a sleeve. One end of the inlet switch body has an inlet, while other end is a closed end. Between the inlet and the closed end is an inlet chamber that communicates with the inlet. The outlet switch body extends outwardly from the closed end of the inlet switch body and features an outlet at its outer end with an outlet chamber therein that communicates with the outlet. The first communication port is formed on the inlet switch body to communicate its interior and exterior, while the second communication port is formed on the outlet switch body for the same purpose. The sleeve is reciprocable and fits over outer surfaces of both the inlet and outlet switch bodies, with an annular groove in a middle section of its inner wall communicating with the first and second communication ports or only the first communication port.

A preferred embodiment of the present invention will be described in detail below, with reference to the accompanying drawings:

### BRIEF DESCRIPTION OF THE DRAWINGS

FIG. 1 is a perspective view of the preferred embodiment of the present invention with one end assembled with a connecting component, and the sleeve in a first position;

FIG. 2 is a perspective view of the preferred embodiment of the present invention with one end assembled with a connecting component, and the sleeve in a second position;

FIG. 3 is an exploded perspective view of the preferred embodiment of the present invention with one end assembled with a connecting component;

FIG. 4 is a cross-sectional view of Section 4-4 of FIG. 1; and

FIG. 5 is a cross-sectional view of Section 5-5 of FIG. 2.

### DETAILED DESCRIPTION OF THE PREFERRED EMBODIMENTS

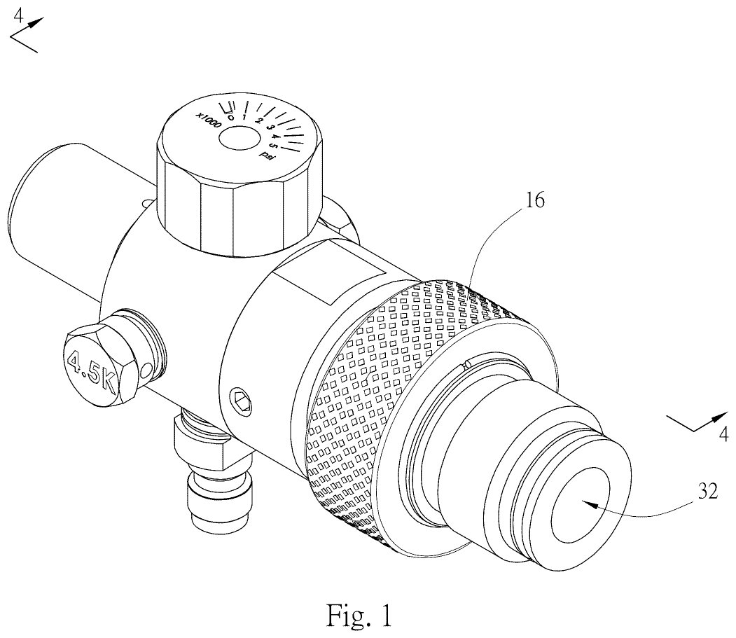

Reference is made to FIGS. 1 to 5. A reciprocating switch for high-pressure fluid lines disclosed in the present invention comprises at least an inlet switch body 12, an outlet switch body 13, a first communication port 14, a second communication port 15, and a sleeve 16.

One end of the inlet switch body 12 has an inlet 22, while other end is a closed end 24. Between the inlet 22 and the closed end 24 is an inlet chamber 26 that communicates with the inlet 22. The inlet 22 is equipped with a connector/connecting component 221 which connects and communicates with a fluid supply component (not shown), such as a high-pressure gas cylinder or an air compressor. The connecting component 221 may include a pressure-reducing mechanism that allows the inlet switch body 12 to receive fluid at an appropriate or reduced pressure. A spring-actuated/elastic actuation direction of this pressure-reducing mechanism may be generally parallel to direction of fluid flow, or may also be generally perpendicular to the direction of fluid flow.

The outlet switch body 13 extends outwardly from the closed end 24 of the inlet switch body 12 and features an outlet 32 at its outer end. Between the outlet 32 and the closed end 24 is an outlet chamber 34 that communicates with the outlet 32. The outlet 32 is used to connect and communicate with a fluid-driven device (not shown), such as a gun, an air gun, a paintball gun, or a riot control gun.

The first communication port 14 is formed by at least one aperture near the closed end 24 that penetrates the inlet switch body 12 and communicates the inlet chamber 26 with an exterior of the inlet switch body 12.

The second communication port 15 is formed by at least one aperture near the closed end 24 that penetrates the outlet switch body 13 and communicates the outlet chamber 34 with an exterior of the outlet switch body 13.

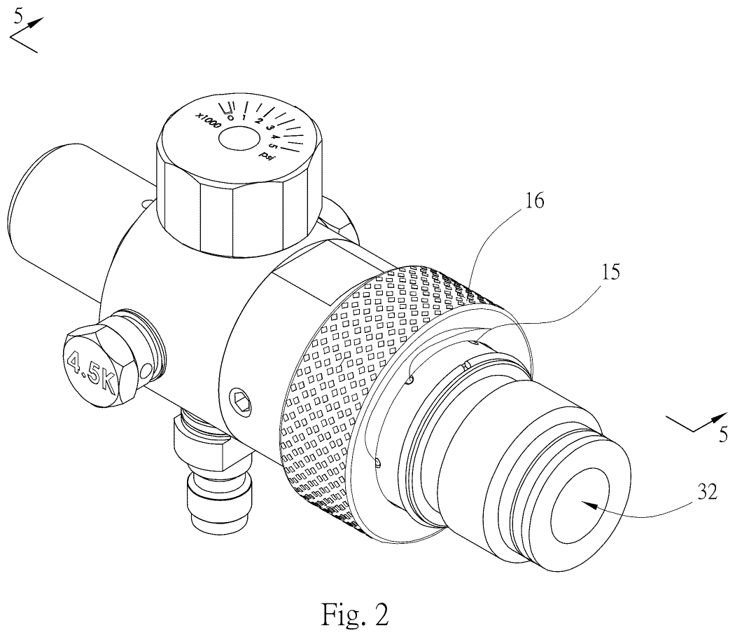

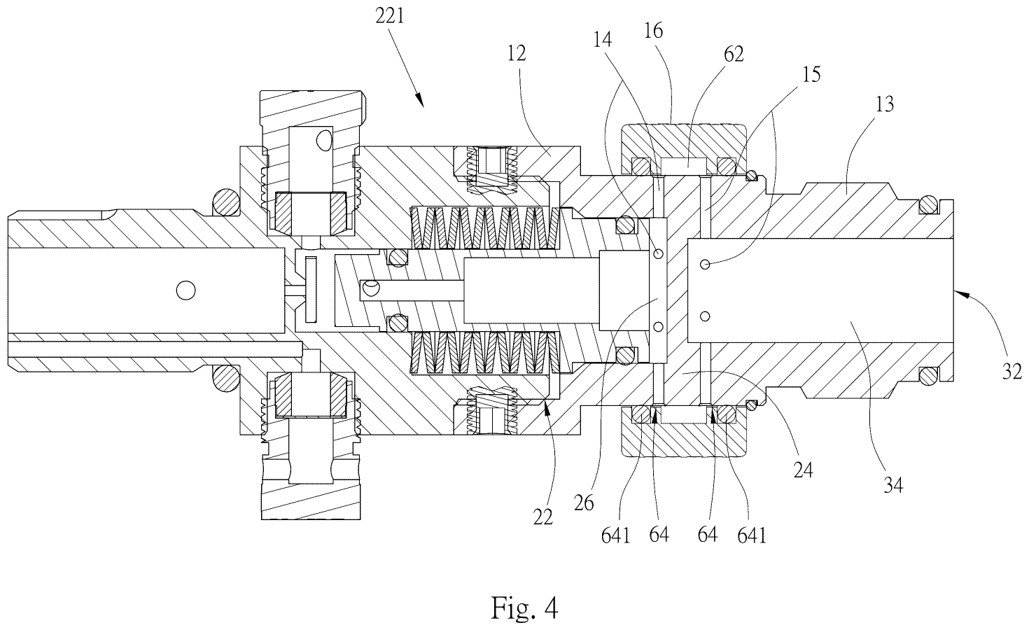

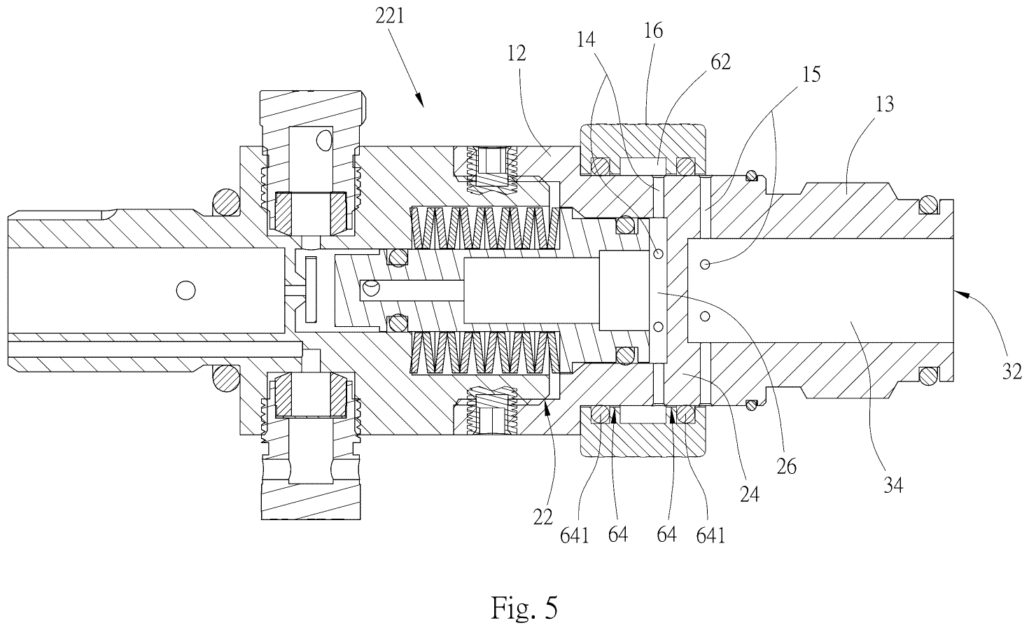

Inner edge shapes at both ends of the sleeve 16 correspond to outer edge shapes of the inlet switch body 12 and the outlet switch body 13, allowing the sleeve 16 to fit airtight and slide over outer surfaces of the inlet switch body 12 and the outlet switch body 13 between a first position (as shown in FIGS. 1 and 4) and a second position (as shown in FIGS. 2 and 5). A middle section of inner wall of the sleeve 16 features an annular groove 62.

Inner wall surfaces 64 at the both ends of the sleeve 16 abut against the outer surfaces of the inlet switch body 12 and the outlet switch body 13, respectively. When the sleeve 16 is in the first position (as shown in FIGS. 1 and 4), the both ends of the sleeve 16 encircle the first communication port 14 and the second communication port 15. The annular groove 62 communicates with the first communication port 14 and the second communication port 15, allowing fluid to enter through the inlet 22 and flow out from the outlet 32. When the sleeve 16 is in the second position (as shown in FIGS. 2 and 5), the both ends of the sleeve 16 encircle the first communication port 14 but do not encircle the second communication port 15, thereby preventing the annular groove 62 from communicating with the second communication port 15. This allows the fluid to enter through the inlet 22 but not flow out of the outlet 32.

The design of the sleeve 16, which fits airtight and slides over the outer surfaces of the inlet switch body 12 and the outlet switch body 13, enables the present invention to quickly switch on or off the flow of fluid into the fluid-driven device.

When the sleeve 16 is in the second position (as shown in FIGS. 2 and 5), both ends of the sleeve 16 encircle the first communication port 14 but do not encircle the second communication port 15. This design allows the present invention to quickly release residual fluid from the fluid-driven device through the second communication port 15, particularly high-pressure fluids such as gas. This prevents the fluid-driven device from being hindered by high-pressure gas, enabling an user to easily and quickly disassemble the fluid-driven device.

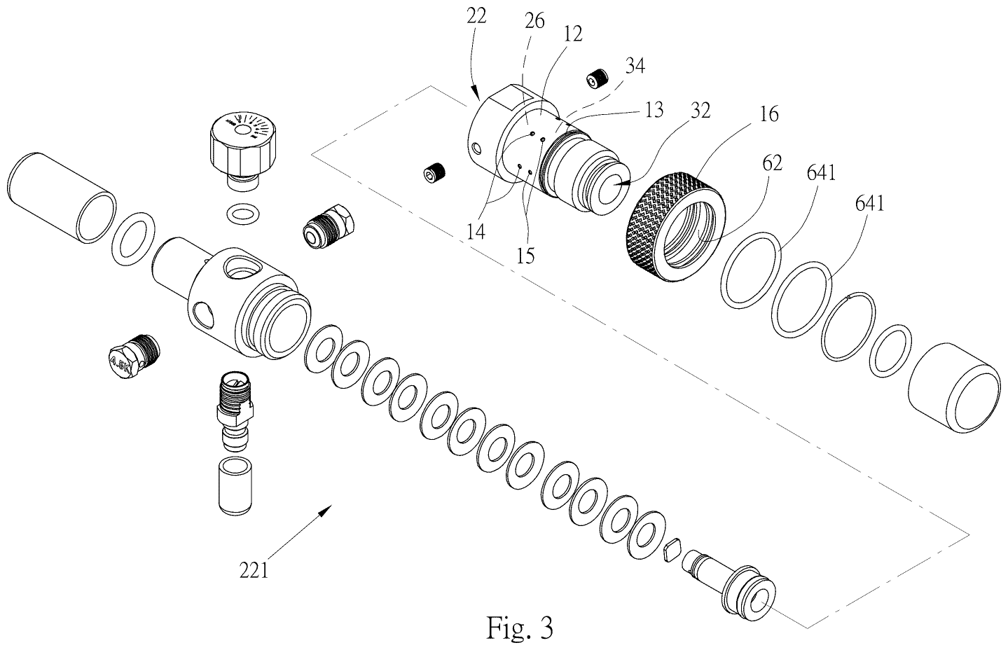

Referring again to FIGS. 3, 4, and 5, in the reciprocating switch for high-pressure fluid lines disclosed in the present invention, the first communication port 14 can be formed by a series of apertures arranged in a spaced annular pattern, while the second communication port 15 can also be formed by a series of apertures arranged in a spaced annular pattern.

Referring again to FIGS. 3, 4, and 5, in the reciprocating switch for high-pressure fluid lines disclosed in the present invention, the inner wall surfaces 64 at the both ends of the sleeve 16 are additionally respectively fitted with an anti-leakage washer 641. When the sleeve 16 is in the first position, the first communication port 14 and the second communication port 15 are positioned between the two anti-leakage washers 641. In the second position, only the first communication port 14 is positioned between the two anti-leakage washers 641. This design enhances airtightness or watertightness and ensures a reliable sealing effect for the present invention.

What is claimed is:

1. A reciprocating switch for high-pressure fluid lines comprising at least:
an inlet switch body, one end of which has an inlet and other end of which is a closed end, an inlet chamber communicating with the inlet being formed between the inlet and the closed end, and the inlet being used to connect and communicate with a fluid supply component;
an outlet switch body, extending outwardly from the closed end of the inlet switch body and featuring an outlet at its outer end, an outlet chamber communicating with the outlet being formed between the outlet and the closed end, and the outlet being used to connect and communicate with a fluid-driven device;
a first communication port, formed by at least one aperture near the closed end penetrating the inlet switch body, and used to communicate the inlet chamber with an exterior of the inlet switch body;
a second communication port, formed by at least one aperture near the closed end penetrating the outlet switch body, and used to communicate the outlet chamber with an exterior of the outlet switch body; and
a sleeve, having inner edge shapes at both ends corresponding to outer edge shapes of the inlet switch body and the outlet switch body, allowing the sleeve to fit and slide over outer surfaces of the inlet switch body and the outlet switch body between a first position and a second position, and inner wall of the sleeve having an annular groove in a middle section; wherein,
inner wall surfaces at the both ends of the sleeve abut against the outer surfaces of the inlet switch body and the outlet switch body, respectively;
when the sleeve is in the first position, the both ends of the sleeve encircle the first communication port and the second communication port, but the annular groove communicates the first communication port and the second communication port, allowing fluid to enter through the inlet and flow out from the outlet; and
when the sleeve is in the second position, the both ends of the sleeve encircle the first communication port but do not encircle the second communication port, thereby preventing the annular groove from communicating with the second communication port, allowing the fluid to enter through the inlet but not flow out of the outlet.

2. The reciprocating switch for high-pressure fluid lines according to claim 1, wherein the first communication port is formed by the series of apertures arranged in a spaced annular pattern.

3. The reciprocating switch for high-pressure fluid lines according to claim 1, wherein the second communication port is formed by the series of apertures arranged in a spaced annular pattern.

4. The reciprocating switch for high-pressure fluid lines according to claim 1, wherein the inner wall surfaces at the both ends of the sleeve are additionally respectively fitted with an anti-leakage washer, so that when the sleeve is in the first position, the first and second communication ports are positioned between the two anti-leakage washers, and when the sleeve is in the second position, only the first communication port is positioned between the two anti-leakage washers.

5. The reciprocating switch for high-pressure fluid lines according to claim 2, wherein the inner wall surfaces at the both ends of the sleeve are additionally respectively fitted with an anti-leakage washer, so that when the sleeve is in the first position, the first and second communication ports are positioned between the two anti-leakage washers, and when the sleeve is in the second position, only the first communication port is positioned between the two anti-leakage washers.

6. The reciprocating switch for high-pressure fluid lines according to claim 3, wherein the inner wall surfaces at the both ends of the sleeve are additionally respectively fitted with an anti-leakage washer, so that when the sleeve is in the first position, the first and second communication ports are positioned between the two anti-leakage washers, and when the sleeve is in the second position, only the first communication port is positioned between the two anti-leakage washers.

7. The reciprocating switch for high-pressure fluid lines according to claim 1, wherein the fluid supply component is a cylinder containing high-pressure gas.

8. The reciprocating switch for high-pressure fluid lines according to claim 2, wherein the fluid supply component is a cylinder containing high-pressure gas.

9. The reciprocating switch for high-pressure fluid lines according to claim 3, wherein the fluid supply component is a cylinder containing high-pressure gas.

10. The reciprocating switch for high-pressure fluid lines according to claim 4, wherein the fluid supply component is a cylinder containing high-pressure gas.

11. The reciprocating switch for high-pressure fluid lines according to claim 1, wherein the fluid-driven device is a gun, an air gun, a paintball gun, or a riot control gun.

12. The reciprocating switch for high-pressure fluid lines according to claim 2, wherein the fluid-driven device is a gun, an air gun, a paintball gun, or a riot control gun.

13. The reciprocating switch for high-pressure fluid lines according to claim 3, wherein the fluid-driven device is a gun, an air gun, a paintball gun, or a riot control gun.

14. The reciprocating switch for high-pressure fluid lines according to claim 4, wherein the fluid-driven device is a gun, an air gun, a paintball gun, or a riot control gun.

15. The reciprocating switch for high-pressure fluid lines according to claim 7, wherein the fluid-driven device is a gun, an air gun, a paintball gun, or a riot control gun.

16. The reciprocating switch for high-pressure fluid lines according to claim 10, wherein the fluid-driven device is a gun, an air gun, a paintball gun, or a riot control gun.
